(19) United States
(12) Patent Application Publication
(10) Pub. No.: US 2008/0236985 A1
(43) Pub. Date: Oct. 2, 2008

(54) WET TYPE FRICTION PLATE

(76) Inventor: Ritsuo TOYA, Fukuroi-shi (JP)

Correspondence Address: MILES & STOCKBRIDGE PC, 1751 PINNACLE DRIVE, SUITE 500, MCLEAN, VA, 22102-3833, US

(21) Appl. No.: 12/058,439

(22) Filed: Mar. 28, 2008

(30) Foreign Application Priority Data
Apr. 2, 2007 (JP) 2007-096487

(51) Int. Cl. F16D 13/64

(52) U.S. Cl. 192/107 R

(57) ABSTRACT

The present invention provides a wet type friction plate having a friction surface formed by securing a plurality of friction material segments to a substantially annular core plate, in which a groove extending through from an inner diameter side to an outer diameter side is formed between the friction material segments, and a recessed portion facing toward the core plate is formed in a side surface of the friction material segment defining the groove.

### BACKGROUND OF THE INVENTION

1. Field of the Invention

The present invention relates to a wet type friction plate used in a clutch or a brake and the like of an automatic transmission (AT) of a vehicle. More specifically, the present invention relates to an improvement in an oil passage formed in a friction surface of a wet type friction plate.

2. Description of the Related Art

In general, a wet type multi-plate clutch including paper friction materials has advantages that a transmission torque can be controlled by adjusting a load applied to a friction surface and that smooth engagement can be achieved during transmission of the torque and is mainly used in a speed change device of the automatic transmission, a torque converter, a starting clutch and the like.

In a wet type multi-plate clutch, friction plates and separator plates are disposed alternately between a drum and a hub of a clutch or a brake so that the clutch is engaged and disengaged by applying to and releasing from a force with respect to the plates by means of a clutch piston, respectively.

In recent years, the automatic transmission of a motor vehicle has been requested to have greater efficiency in order to meet the requirement for reducing consumption of fuel and, in the wet type friction plate used in the automatic transmission, further reduction in drag torque during an idle rotation has been requested.

In general, in many cases, a wet type multi-plate clutch used in an automatic transmission (AT) is designed so that lubricating oil can easily been flown from an inner peripheral side to an outer peripheral side of the friction plate, thereby reducing the drag torque. Such arrangements for reducing the drag torque are known, for example, as disclosed in Japanese Patent Application Laid-open No. 2002-130323. In the clutches disclosed in the Japanese Patent Application Laid-open No. 2002-130323, the friction plate is provided with oil passages extending through from an inner periphery to an outer periphery in a radial direction to facilitate escaping of lubricating oil from the friction surface during the engagement.

However, in recent years, in order to improve speed change response so as to enhance power performance as well as the reduction in fuel consumption, a clearance between the friction plate and the separator plate has been made narrower than that in the prior art, with the result that the drag torque tended to increase during the idle rotation due to the presence of the interposed oil film.

The oil supplied to the oil passage extending through from the inner periphery to the outer periphery in the radial direction is drawn to the friction material, and, if the drawn oil enters between the friction plate and the separator plate, the oil is hard to be discharged; this tendency becomes noticeable particularly in areas where the clearance between the friction plate and the separator plate is small and the number of rotations is small, and, in such areas, the drag torque is increased due to viscosity between the friction plate and the associated separator plate.

In general, the drag torque during the idle rotation is generated by viscous resistance of oil existing between the friction surface of the friction plate to which the friction material is stuck and the separator plate as an associated metal plate.

The lubricating oil supplied to the multi-plate clutch is supplied to the friction surface mainly through grooves provided in the friction plate. However, if the amount of lubricating oil is great, excessive oil is supplied through the grooves, thereby increasing the drag torque during the idle rotation.

Thus, it is requested to suppress the migration of excessive lubricating oil to the friction surface, without decreasing lubricating performance.

### SUMMARY OF THE INVENTION

Accordingly, an object of the present invention is to provide a wet type friction plate which can suppress the migration of excessive lubricating oil to a friction surface, without decreasing lubricating performance, thereby greatly reducing drag torque during an idle rotation.

To achieve the above object, the present invention provides a wet type friction plate having a friction surface formed by securing a plurality of friction material segments to a substantially annular core plate, in which a groove extending through from an inner diameter side to an outer diameter side is formed between the friction material segments, and a recessed portion facing toward the core plate is formed in a side surface of the friction material segment defining the groove.

According to the present invention, the following advantages can be obtained.

Since the recessed portion is formed in the side surface of the friction material segment defining the groove and facing toward the core plate, the migration of excessive lubricating oil from the groove to the friction surface can be suppressed. Accordingly, an amount of lubricating oil drawn from an oil passage to the friction surface can be reduced and the lubricating oil can smoothly be discharged toward the outer diameter side, with the result that the drag torque during the idle rotation can be reduced. Particularly during a low rotation, the drag torque can be reduced greatly.

By using the segments each having the recessed portion facing toward the core plate, the groove is formed between the friction material segments. With this arrangement, the lubricating oil supplied to the groove between the friction material segments is not supplied to the friction surface excessively, thereby suppressing the drag torque during the idle rotation.

Further, with the arrangement in which the recessed portion is formed below the friction surface, when the friction material segments are used, the friction plate can easily be manufactured.

Further features of the present invention will become apparent from the following description of exemplary embodiments with reference to the attached drawings.

### BRIEF DESCRIPTION OF THE DRAWINGS

FIG. 1 is a partial axial sectional view of a wet type multi-plate clutch having friction plates of the present invention.

FIG. 2 is a front view of a friction plate according to embodiments of the present invention.

FIG. 3 is a partial sectional view of a friction plate along a circumferential direction, showing a first embodiment of the present invention.

FIG. 4 is a partial sectional view of a friction plate along a circumferential direction, showing a second embodiment of the present invention.

### DESCRIPTION OF THE EMBODIMENTS

Now, the present invention will be fully described with reference to the accompanying drawings. Incidentally, in the drawings, the same parts or elements are designated by the same reference numerals.

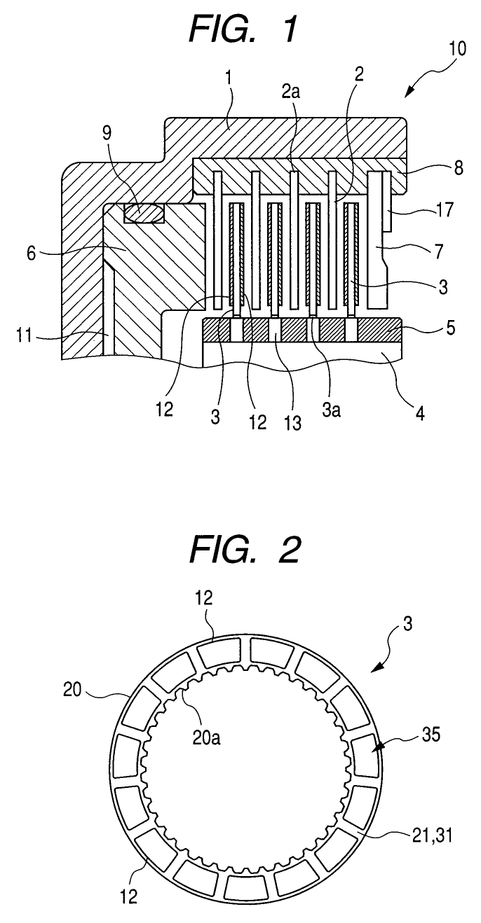

FIG. 1 is a partial axial sectional view of a wet type multi-plate clutch 10 having friction plates of the present invention.

The wet type multi-plate clutch 10 comprises a substantially cylindrical drum or clutch case 1 having an opened axial one end, a hub 4 disposed coaxially within the clutch case 1 and rotatable relative to the clutch case, a plurality of annular separator plates 2 disposed, for an axial movement, in a spline portion 8 provided on an inner periphery of the clutch case 1 and a plurality of annular friction plates 3 disposed in a spline portion 5 provided on an outer periphery of the hub 4 and arranged alternately with the separator plates 2 in an axial direction. Plural separator plates 2 and friction plates 3 are provided.

The wet type multi-plate clutch 10 includes a piston 6 for urging the separator plates 2 and the friction plates 3 to engage these plates with each other, a backing plate 7 provided on the inner periphery of the clutch case 1 to fixedly hold the separator plates 2 and the friction plates 3 at an axial one end of the clutch, and a stop ring 17 for holding the backing plate.

As shown in FIG. 1, the piston 6 is slidably (in an axial direction) disposed within a closed end portion of the clutch case 1. An O-ring 9 is disposed between an outer peripheral surface of the piston 6 and an inner surface of the clutch case 1. Further, a seal member (not shown) is also provided between an inner peripheral surface of the piston 6 and an outer peripheral surface of a cylindrical portion (not shown) of the clutch case 1. Accordingly, an oil-tight hydraulic chamber 11 is defined between an inner surface of the closed end portion of the clutch case 1 and the piston 6.

In each of the friction plates 3 held by the hub 4 for the axial sliding movement, friction materials 12 having predetermined coefficient of friction are stuck to both surfaces of the friction plate. However, the friction material 12 may be provided on only one surface of the friction plate 3. Further, the hub 4 is provided with lubricating oil supplying ports 13 extending through in a radial direction so that lubricating oil is supplied from an inner diameter side to an outer diameter side of the wet type multi-plate clutch 10.

In the wet type multi-plate clutch 10 having the above-mentioned arrangement, the clutch is tightened or engaged and released or disengaged in the following manner. A condition shown in FIG. 1 is a clutch released condition in which the separator plates 2 are separated from the friction plates 3. In the released condition, the piston 6 abuts against the closed end portion of the clutch case 1 by a biasing force of a return spring (not shown).

From this condition, in order to tighten or engage the clutch, hydraulic pressure is supplied to the hydraulic chamber 11 defined between the piston 6 and the clutch case 1. As the hydraulic pressure is increased, the piston 6 is shifted to the right in FIG. 1 in opposition to the biasing force of the return spring (not shown), thereby closely contacting the separator plates 2 with the wet type friction plates 3 to tighten the clutch.

After the engagement, to release the clutch again, the hydraulic pressure is released from the hydraulic chamber 11. When the hydraulic pressure is released, by the biasing force of the return spring (not shown), the piston 6 is shifted until it abuts against the closed end portion of the clutch case 1. In this way, the clutch is released or disengaged.

FIG. 2 is a front view of a friction plate 3 according to embodiments of the present invention. The friction plate 3 is constituted by securing or securing a plurality of friction material segments 12 disposed equidistantly along a circumferential direction onto an annular core plate 20 provided at its inner periphery with splines 20a adapted to be engaged by a spline portion 5 of the hub 4. A groove 21 (31) is formed between the friction material segments 12. A friction surface 35 is formed by the plurality of friction material segments 12. In FIG. 2, although all of the friction material segments 12 have the same configurations, friction material segments having different configurations may be used.

### First Embodiment

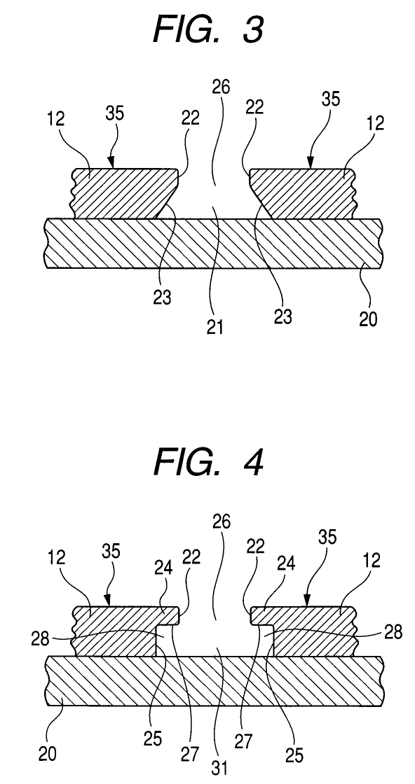

FIG. 3 is a partial sectional view of a friction plate 3 along a circumferential direction, showing a first embodiment of the present invention. The friction plate 3 is formed by securing a plurality of friction material segments 12 to the core plate 20 by an adhesive or the like.

A groove 21 extending through an inner diameter side to an outer diameter side is provided between the friction material segments 12, and a recessed portion facing toward the core plate 20 is formed on a circumferential side surface 22 of the friction material segment 12 defining the groove 21.

The recessed portion is formed as a tapered portion 23 inclined from the side surface 22 toward the inside of the friction material segment 12. As can be seen from FIG. 3, a circumferential width of the groove 21 at the position of the core plate 20 is greater than a circumferential width of an opening portion 26 of the groove 21. Two tapered portions of the adjacent friction material segments are opposed to each other to define the groove 21.

Accordingly, the narrowed opening portion 26 of the groove 21 serves to hold the lubricating oil within the groove so that the migration of the excessive lubricating oil to the friction surface 35 through the opening portion 26 is suppressed. In this case, since the groove 21 extends through from the inner diameter side to the outer diameter side, the lubricating oil can flow smoothly from the inner diameter side to the outer diameter side i.e. toward an engaging element of the wet type multi-plate clutch 10, thereby improving the lubricating performance of the clutch.

### Second Embodiment

FIG. 4 is a partial sectional view of a friction plate 3 along a circumferential direction, showing a second embodiment of the present invention. Similar to the first embodiment, the friction plate 3 is formed by securing a plurality of friction material segments 12 to the core plate 20 by an adhesive or the like.

Also in the second embodiment, a groove 31 extending through an inner diameter side to an outer diameter side is provided between the friction material segments 12, and a recessed portion facing toward the core plate 20 is formed on a circumferential side surface 22 of the friction material segment 12 defining the groove 31.

In the second embodiment, the recessed portion is formed as a recess 28 cut from the side surface 22 toward the inside of the friction material segment 12. As can be seen from FIG. 4, a circumferential width of the groove 31 at the position of the core plate 20 is greater than a circumferential width of an opening portion 26 of the groove 31. Two recesses 28 of the adjacent friction material segments are opposed to each other to define the groove 31.

The groove 31 is formed as the recesses 28 defined by the surface of the core plate 20, wall surfaces 25 obtained by cutting the side surfaces 22 of the adjacent friction material segments 12, and (not cut) protruded portions 24 remaining on the wall portions 25. Lower surfaces 27 of the protruded portions 24 can suppress the migration of excessive lubricating oil from the groove 31 to the friction surface 35 through the opening portion 26 more effectively.

Similar to the first embodiment, since the groove 31 extends through from the inner diameter side to the outer diameter side, the lubricating oil can flow smoothly from the inner diameter side to the outer diameter side i.e. toward an engaging element of the wet type multi-plate clutch 10, thereby improving the lubricating performance of the clutch.

Although the recessed portions in the first and second embodiments i.e. the tapered portion 23 and the recess 28 defined by the wall surface 25 and the lower surface 27 are formed by compression of a press, the recessed portions may be formed by the cutting.

In the above-mentioned embodiments, although the tapered portion 23 and the recess 28 as the recessed portions can be formed after the friction material segments are secured to the core plate 20, here, the recessed portions are formed before the friction material segments are secured to the core plate.

Further, the tapered portion 23 of the first embodiment and the recess 28 of the second embodiment can be combined in the circumferential direction. That is to say, the groove 21 and the groove 31 can be arranged alternately or be mixed in the circumferential direction.

Similarly, the tapered portion 23 and the recess 28 can be mixed in the same groove. That is to say, one of the side surfaces of the groove can be formed as the tapered portion 23 and the other side surface can be formed as the recess 28. Further, it should be noted that the number of the friction material segments 12 to be secured to the core plate 20 and the number of the grooves can be selected voluntarily.

The friction material segment 12 is secured to the core plate 20 to which the adhesive is coated, but, a seal-like friction material segment 12 having a rear surface to which the adhesive was coated may be rested on the core plate and be secured to the core plate by pressure and heat.

Further, in the above-mentioned embodiments, although grooves 21 or grooves 31 having the same circumferential widths are used, grooves having different widths may be formed on the same core plate.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-96487, filed Apr. 2, 2007, which is hereby incorporated by reference herein in its entirety.

What is claimed is:

1. A wet type friction plate having a friction surface formed by securing a plurality of friction material segments to a substantially annular core plate, wherein:
a groove extending through from an inner diameter side to an outer diameter side is formed between said friction material segments; and a recessed portion facing toward said core plate is formed in a circumferential side surface of said friction material segment defining said groove.

2. A wet type friction plate according to claim 1, wherein said recessed portion is formed by compression of a press.

3. A wet type friction plate according to claim 1, wherein said recessed portion is formed by cutting.

4. A wet type friction plate according to claim 1, wherein said recessed portion is constituted by a tapered portion inclined from said side surface toward the inside of said friction material segment.

5. A wet type friction plate according to claim 1, wherein said recessed portion is constituted by a recess provided by cutting, compression or the like.
